(19) United States
(12) Patent Application Publication
(10) Pub. No.: US 2009/0016612 A1
(43) Pub. Date: Jan. 15, 2009

(54) METHOD OF REFERENCE CONTOUR PROPAGATION AND OPTIMIZATION

(75) Inventors: Steven Lobregt, Eindhoven (NL); Marcel Breeuwer, Eindhoven (NL); Guillaume Leopold Theodorus Hautvast, Eindhoven (NL); Frans Andreas Gerritsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,247

(22) PCT Filed: Sep. 27, 2006
(86) PCT No.: PCT/IB2006/053519

§ 371 Date: Aug. 14, 2008

(30) Foreign Application Priority Data
Sep. 28, 2005 (EP) 05108938.1

(51) Int. Cl. G06T 5/00

(52) U.S. Cl. 382/199

(57) ABSTRACT

The invention relates to a detection method (300) of detecting a boundary in a second image data from an image dataset on the basis of a reference contour in a first image data from the image dataset, the detection method (300) comprising a generating step (320) for generating a reference profile using the first image data on the basis of a qualifying characteristic, the reference profile comprising a reference profile node defined on the basis of the reference contour, a selecting step (330) for selecting a target profile using the second image data on the basis of the reference profile, and a mapping step (335) for mapping the reference profile node into the second image data on the basis of the target profile, thereby detecting the second boundary. A reference profile generated on the basis of a qualifying characteristic is more accurate in detecting the boundary in the second image than an arbitrarily generated reference profile. Hence, the detection method (300) of the current invention is more accurate in detecting a boundary in a second image data from an image dataset on the basis of a reference contour in a first image data from the image dataset.

This invention relates to a detection method of detecting a boundary in a second image data from an image dataset on the basis of a reference contour in a first image data from the image dataset.

The invention further relates to a detection system for detecting a boundary in a second image data from an image dataset on the basis of a reference contour in a first image data from the image dataset.

The invention further relates to an acquisition system for acquiring an image dataset comprising said detection system.

The invention further relates to a workstation comprising said detection system.

The invention further relates to a computer program product to be loaded by a computer arrangement, comprising instructions for detecting a boundary in a second image data from an image dataset on the basis of a reference contour in a first image data from the image dataset.

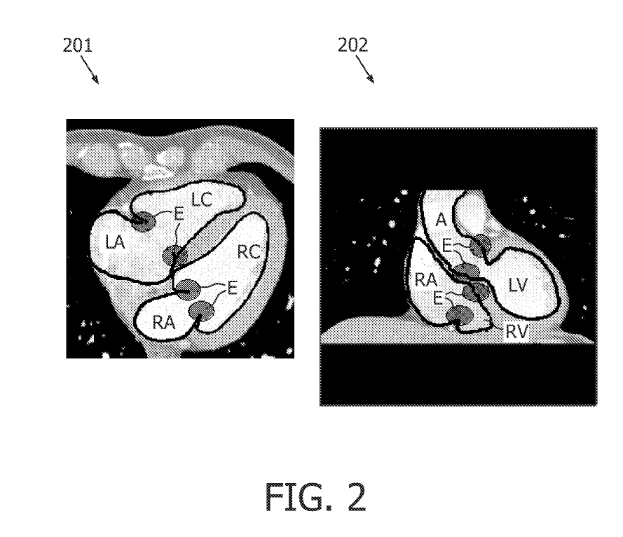

An embodiment of the method of the kind described in the opening paragraph is described in an article “Contour Extraction from Cardiac MRI Studies Using Snakes” by Surendra Ranganath, published in IEEE Transactions on Medical Imaging, vol. 14, no. 2, June 1995, pp. 328-338, hereinafter referred to as Ref. 1. This document describes a method for automatic detection of left ventricular contours from cardiac Magnetic Resonance (MR) Imaging studies. Given a reference contour in a first image, represented by a finite number of reference contour nodes, a boundary in a second image is detected. In a first step of the method, a reference profile is extracted from the first image. The base of the reference profile and the reference contour intersect each other at a right angle. The intersection of the reference contour by the base of the reference profile defines a reference profile node. In Ref. 1, the reference profile node coincides with a reference contour node. Moreover, the reference profile is extracted in such a way that the reference profile node is at the center of the base of the reference profile as illustrated in FIG. 2 of Ref. 1. In a further step of the method, for each reference profile a search for a target profile is performed. The search domain comprises candidate target profiles extracted from the second image, whose bases are aligned with a projection of the base of the reference profile. A match measure based on a measure of similarity of the reference profile to a candidate target profile is used to determine the target profile. The target profile is a candidate target profile corresponding to the maximum of the match measure. The reference profile node is mapped into the second image by mapping the base of the reference profile comprising the reference profile node onto the base of the corresponding target profile. The mapped reference profile node defines a boundary contour node. The boundary contour, defined by the boundary contour nodes, delineates the boundary detected in the second image. In a further step of the method, the boundary contour energy comprising a bending energy term and a stretching energy term is minimized. The bending energy is minimal when the local curvature of the boundary contour is constant. The stretching energy is minimal when the displacements of the boundary contour nodes from their detected locations are zero. The locations of the boundary contour nodes at a minimum of the boundary contour energy yield the optimized locations of the boundary contour nodes. The optimized boundary contour is smoother than a non-optimized boundary contour.

The above detection method is useful for detecting isolated boundaries with no other boundaries present in a neighborhood of the detected boundary. If there are, however, multiple boundaries close to each other, the number of features comprised in a reference profile generated using the method of Ref. 1 may be large. The reference profile may comprise multiple substantially vertical edges, hereinafter referred to as vertical edges, corresponding to the multiple boundaries separating areas of different image intensities. The multiple vertical edges correspond to multiple intersections of the multiple boundaries with the base of the reference profile. In order to find a good match for such a reference profile, the strong features comprised in the reference profile must be matched by respective features in a target profile. However, candidate target profiles extracted from the second image may be very different from the reference profile. The distances between vertical edges, the heights of vertical edges, and even the number of vertical edges may be different in the two profiles. For example, in a cardiac MR slice, the thickness of myocardium depends on the axis of cardiac anatomy, on the height at which the slice data is recorded, and on the cardiac phase. Therefore the reference profile extracted from the first image may be very different from the candidate target profiles extracted from the second image acquired, for example, from a different MR slice or for the same slice at a different phase of the cardiac cycle. Hence, using a match measure of Ref. 1 for detecting an epicardial and/or an endocardial boundary may not produce satisfactory results. This explains why the method of Ref. 1 is shown to be only qualitatively but not quantitatively useful for detecting an endocardial boundary despite some further processing of the detected contours as described on p. 333 of Ref. 1. Moreover, detecting epicardial contours failed completely due to complexity of features in the epicardial region.

The problem of detecting multiple boundaries in an image is addressed by Luuk Spreeuwers and Marcel Breeuwer in an article “Detection of left ventricular epi- and endocardial borders using coupled active contours”, published in Computer Assisted Radiology and Surgery, 2003, pp. 1147-1152. The article describes a method based on coupled reference contours: an endocardial reference contour and an epicardial reference contour. Each reference profile base intersects both contours thus comprising two reference profile nodes: an endocardial reference profile node and an epicardial reference profile node. In this method, the search for the target profile allows scaling the reference profile in order to maximize a measure of similarity of the reference profile to a candidate target profile. The experiments show that this approach is more robust in detecting epi- and endocardial borders in cine short-axis MR recordings of a slice acquired at different phases of the cardiac cycle than a single contour approach of Ref. 1. The drawback of this method is that it fails to work for multiple MR slices because the difference between two different slices is much larger than the difference between the same slice recorded at two consecutive phases of the cardiac cycle. The application of this method is also limited to detecting just two coupled boundaries.

It is an object of the invention to provide a detection method of the kind described in the opening paragraph, which is more accurate in detecting a boundary in a second image data from an image dataset on the basis of a reference contour in a first image data from the image dataset.

This object of the invention is achieved in that the detection method of detecting a boundary in a second image data from an image dataset on the basis of a reference contour in a first image data from the image dataset comprises:

a generating step for generating a reference profile using the first image data on the basis of a qualifying characteristic, the reference profile comprising a reference profile node defined on the basis of the reference contour;

a selecting step for selecting a target profile using the second image data on the basis of the reference profile; and

a mapping step for mapping the reference profile node into the second image data on the basis of the target profile, thereby detecting the second boundary.

The reference profile generated in the generating step using the first image data and comprising a reference profile node defined on the basis of the reference contour determines the target profile selected using the second image data on the basis of the reference profile. The reference profile and the target profile determine the mapping of the reference profile node into the second image data. The mapping of the reference profile node into the second image data determines the boundary node. The set of boundary nodes defines the boundary contour delineating the boundary in the second image data. Hence, the success of the detection method of detecting a boundary in the second image data relies on the reference profile. Therefore the reference profile must be generated with great care to enable finding the best possible target profile. To improve the generation of the reference profile, the reference profile of the current invention is generated on the basis of a qualifying characteristic. Certain qualifying characteristics such as an angle between the reference contour and the base of the reference profile and/or a distance from the reference profile node comprised in the base of the reference profile to a predefined end of the base of the reference profile can be imposed on the reference profile by using a proper generation method. Other qualifying characteristics such as the type and/or the number of features comprised in the reference profile must be computed for a candidate reference profile from the first image data. After evaluating the qualifying characteristic of the candidate reference profile, the candidate reference profile is accepted or rejected as the reference profile. A reference profile generated on the basis of a qualifying characteristic is more accurate in detecting the boundary in the second image than an arbitrarily generated reference profile. Hence, the detection method of the current invention is more accurate in detecting a boundary in a second image data from an image dataset on the basis of a reference contour in a first image data from the image dataset.

In an embodiment of the detection method according to the invention, the qualifying characteristic is based on a location of the reference profile relative to the reference contour. Examples of qualifying characteristics of this type comprise the length of the base of the reference profile, the distribution of sampling points in the reference profile, the angle between the reference contour and the base of the reference profile, and the distance from the reference profile node to an end of the base of the reference profile. An optimal qualifying characteristic based on the location of the reference profile relative to the reference contour is determined on the basis of the anatomical structure of interest comprised in the image dataset to which the detection method is applied.

In a further embodiment of the detection method according to the invention, the reference profile node is located in a substantially off-center position of the reference profile, possibly near an end of the base of the reference profile. In case of detecting a boundary in a second image data comprising multiple boundaries this method allows generating a reference profile, which may cross fewer boundaries and thus may comprise fewer features than a reference profile comprising the reference profile node near the center of the base. Such a reference profile with fewer features is more likely to be matched in the selecting step by a good target profile selected using the second image data on the basis of the reference profile.

In a further embodiment of the detection method according to the invention, the qualifying characteristic is based on a feature of the reference profile. The choice of features to be comprised in the reference profile may be very important for selecting a good matching target profile in the selecting step. The feature is, for example, the number of vertical edges comprised in the reference profile of intensities. Multiple candidate reference profiles from the first image data are evaluated. A candidate reference profile comprising a predefined number of vertical edges is accepted as the reference profile. Alternatively, the detection method may be applied to profiles of first derivatives. In this case the respective feature may be the number of peaks in the reference profile of first derivatives.

In a further embodiment of the detection method according to the invention, the qualifying characteristic is based on a measure of similarity of the reference profile to the target profile. Multiple candidate reference profiles from the first image data are generated. For each candidate reference profile a matching candidate target profile is selected in the selecting step. A measure of similarity of the candidate reference profile to the candidate target profile is computed. The measure of similarity is optimized as a function of the candidate reference profile. The optimal candidate reference profile and the corresponding candidate target profile are accepted as the reference profile and as the target profile, respectively. Optionally, known optimization methods such as the steepest ascend method or the conjugate gradient method may be employed to search for a candidate reference profile optimizing the measure of similarity.

In a further embodiment of the detection method according to the invention, the detection method further comprises an adjusting step for adjusting the reference profile. The reference profile may be smoothed to reduce the influence of artifacts present in the first image data. Optionally, the reference profile may be clipped to decrement the number of features comprised in said reference profile.

In a further embodiment of the detection method according to the invention, the first image data corresponds to a first cross-section of the image dataset by a first plane and the second image data corresponds to a second cross-section of the image dataset by a second plane wherein the first plane and the second plane are substantially mutually parallel. Thus the method is useful for detecting boundaries in an image dataset arranged as a sequence of cross sections by substantially mutually parallel planes, for example, for detecting boundaries in a stack of MR slices. Such arrangement is particularly advantageous for segmenting an object comprised in the image dataset on the basis of the detected boundaries.

In a further embodiment of the detection method according to the invention, the first image data corresponds to a first data acquisition time and the second image data corresponds to a second data acquisition time. Thus the detection method is useful for detecting a moving boundary depicted in a time-series of image data comprised in the image dataset. For example, the detection method is useful for detecting epi- and endocardial boundaries in a sequence of frames, each frame depicting same MR slice acquired at a different phase of the cardiac cycle.

It is a further object of the invention to provide a detection system of the kind described in the opening paragraph that is more accurate in detecting a boundary in a second image data from an image dataset on the basis of a reference contour in a first image data from the image dataset. This is achieved in that the detection system for detecting a boundary in a second image data from an image dataset on the basis of a reference contour in a first image data from the image dataset comprises:

a generating unit for generating a reference profile using the first image data on the basis of a qualifying characteristic, the reference profile comprising a reference profile node defined on the basis of the reference contour;

a selecting unit for selecting a target profile using the second image data on the basis of the reference profile; and

a mapping unit for mapping the reference profile node into the second image data on the basis of the target profile, thereby detecting the second boundary.

In an embodiment of the detection system according to the invention, the detection system further comprises a segmentation unit for segmenting the image dataset on the basis of the detected boundary. By combining the detected boundaries from multiple 2D image data such as MR slices, the segmentation unit can assemble an object comprised in the 3D image dataset such as a heart.

It is a further object of the invention to provide an image acquisition system of the kind described in the opening paragraph that is more accurate in detecting a boundary in a second image data from an image dataset on the basis of a reference contour in a first image data from the image dataset. This is achieved in that the image acquisition system comprises a detection system for detecting a boundary in a second image data from an image dataset on the basis of a reference contour in a first image data from the image dataset, the detection system comprising:

a generating unit for generating a reference profile using the first image data on the basis of a qualifying characteristic, the reference profile comprising a reference profile node defined on the basis of the reference contour;

a selecting unit for selecting a target profile using the second image data on the basis of the reference profile; and

a mapping unit for mapping the reference profile node into the second image data on the basis of the target profile, thereby detecting the second boundary.

It is a further object of the invention to provide a workstation of the kind described in the opening paragraph that is more accurate in detecting a boundary in a second image data from an image dataset on the basis of a reference contour in a first image data from the image dataset. This is achieved in that the workstation comprises a detection system for detecting a boundary in a second image data from an image dataset on the basis of a reference contour in a first image data from the image dataset, the detection system comprising:

a generating unit for generating a reference profile using the first image data on the basis of a qualifying characteristic, the reference profile comprising a reference profile node defined on the basis of the reference contour;

a selecting unit for selecting a target profile using the second image data on the basis of the reference profile; and

a mapping unit for mapping the reference profile node into the second image data on the basis of the target profile, thereby detecting the second boundary.

It is a further object of the invention to provide a computer program product of the kind described in the opening paragraph that is more accurate in detecting a boundary in a second image data from an image dataset on the basis of a reference contour in a first image data from the image dataset. This is achieved in that the computer program product to be loaded by a computer arrangement, comprising instructions for detecting a boundary in a second image data from an image dataset on the basis of a reference contour in a first image data from the image dataset, the computer arrangement comprising a processing unit and memory, the computer program product, after being loaded, provides said processing unit with the capability to carry out the following tasks:

generating a reference profile using the first image data on the basis of a qualifying characteristic, the reference profile comprising a reference profile node defined on the basis of the reference contour;

selecting a target profile using the second image data on the basis of the reference profile; and

mapping the reference profile node into the second image data on the basis of the target profile, thereby detecting the second boundary.

Modifications and variations thereof, of the detection system, of the image acquisition system, of the workstation, and/or of the computer program product, which correspond to modifications of the detection method and variations thereof, being described, can be carried out by a skilled person on the basis of the present description.

The detection method of the present invention is especially useful for detecting a boundary in a second 2D image data from a 3D image dataset on the basis of a reference contour in a first 2D image data from the 3D image dataset. However, this method can be also used for detecting a boundary in a 3D second image data from a 4D image dataset on the basis of a reference contour in a first 3D image data from the 4D image dataset. The modification of the method, of the detection system, of the image acquisition system, of the workstation, and/or of the computer program product being obvious to a skilled person can be carried out on the basis of the description of the current invention. The image dataset can be routinely generated nowadays by various data acquisition modalities such as Magnetic Resonance Imaging (MRI)), Computed Tomography (CT), Ultrasound (US), Positron Emission Tomography (PET), and Single Photon Emission Computed Tomography (SPECT).

These and other aspects of the detection method, of the detection system, of the image acquisition system, of the workstation, and of the computer program product according to the invention will become apparent from and will be elucidated with respect to the implementations and embodiments described hereinafter and with reference to the accompanying drawings, wherein:

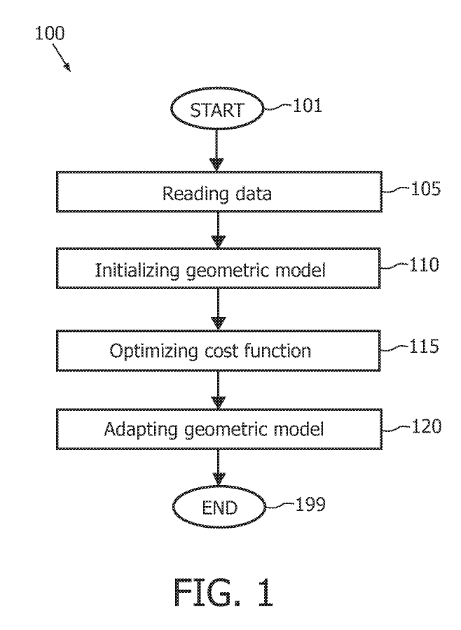

FIG. 1 schematically illustrates a detection method according to prior art;

FIG. 2 schematically illustrates a detection method according to the current invention;

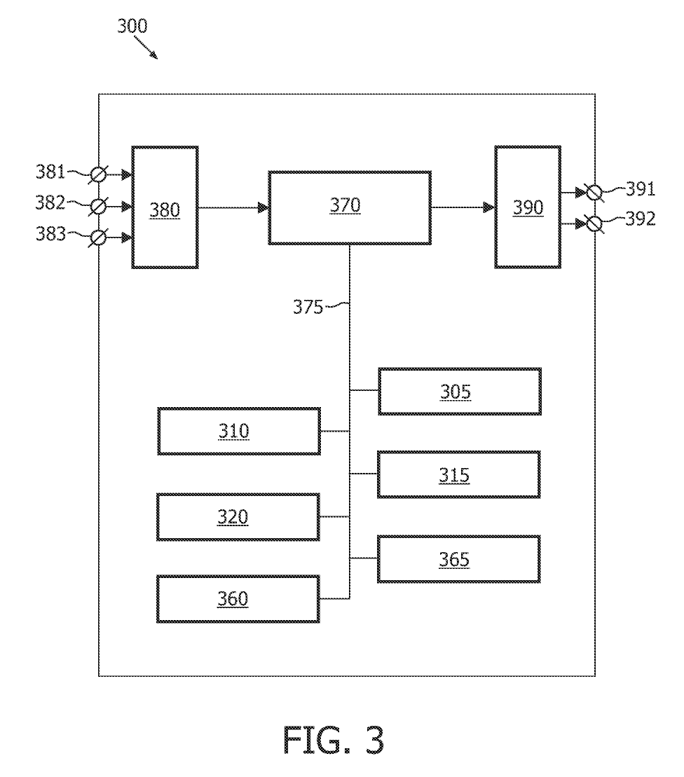

FIG. 3A shows a flowchart of an exemplary embodiment of the detection method;

FIG. 3B shows a flowchart of an exemplary embodiment of the generating step of the detection method;

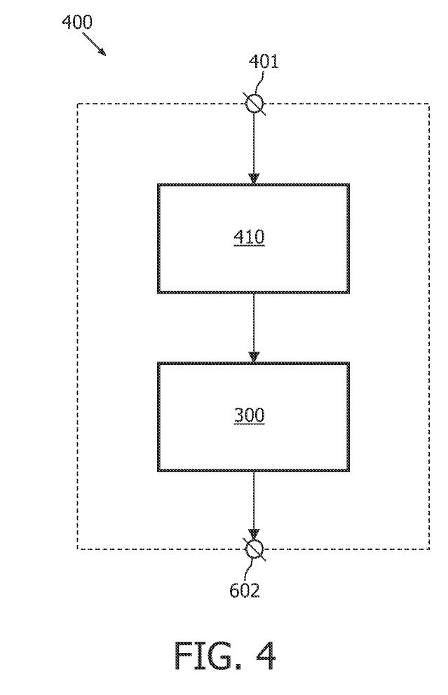

FIG. 4 schematically illustrates a tangent smoothing technique;

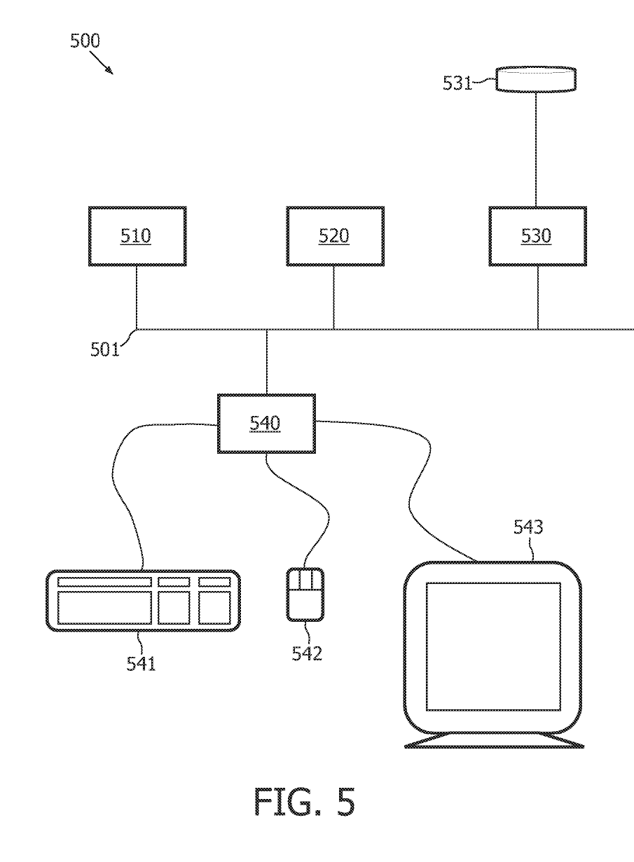

FIG. 5 schematically shows an embodiment of the detection system;

FIG. 6 schematically shows an embodiment of the image acquisition system; and

FIG. 7 schematically shows an embodiment of the workstation.

Same reference numerals are used to denote similar parts throughout the figures.

FIG. 1 schematically illustrates a detection method according to prior art. In the left column, there are two standard reference profiles generated as described in Section IV B of Ref. 1: a reference profile of intensities 110R and a related reference profile of first derivatives 120R, which are generated using data from a schematic first image 150R. The first image comprises areas of different intensities, separated by reference boundaries 141R and 142R. The first reference boundary 141R is delineated by a reference contour 140R represented by a plurality of reference contour nodes. The reference profile base 130R of the reference profile of intensities 110R and of the reference profile of first derivatives 120R and the reference contour 140R intersect each other defining the reference profile node 131R. The reference profile node 131R coincides with a reference contour node of the reference contour 140R. The reference profile node 131R is at the center of the reference profile base 130R. A first reference vertical edge 111R of the reference profile of intensities 110R and the related first reference peak 121R of the reference profile of first derivatives 120R indicate the intersection of the base 130R and of a first reference boundary 141R in the first image 150R. There is a second reference vertical edge 112R in the reference profile of intensities 110R and a related second reference peak 122R in the reference profile of first derivatives 120R. The second reference vertical edge 112R and the second reference peak 122R indicate the intersection of the base 130R and of a second reference boundary 142 in the first image 150R.

In the right column of FIG. 1, there are two target profiles: a target profile of intensities 110T and a related target profile of first derivatives 120T, which are generated using data from a schematic second image 150T. The second image 150T comprises structures similar to those comprised in the first image 150R. Like the first image 150R, the second image 150T comprises three areas of different intensities, separated by target boundaries 141T and 142T. However, the target boundaries 141T and 142T are displaced relative to the reference boundaries 141R and 142R, respectively. A reference contour 140T represented by a plurality of reference contour nodes, mapped from the first image 150R into the second image 150T, shows the original location of the first reference boundary 141R. The target base 130T of the target profile of intensities 110T and of the target profile of first derivatives 120T and the first target boundary 141T intersect each other at the boundary contour node 131T, which has to be detected. The boundary contour node 131T is at the center of the target base 130T. The target profile of intensities 110T and the target profile of first derivatives 120T should be the profiles matching the reference profile of intensities 110R and the reference profile of first derivatives 120R, respectively. The target profile of intensities 110T comprises a target vertical edge 110T and the target profile of first derivatives 120T comprises a target peak 121R, both at the location of the boundary contour node 131T. However, there is no second target vertical edge in the target profile of intensities 110T and no related second target peak in the target profile of first derivatives 120T. Therefore, the target profile of intensities 110T and the target profile of first derivatives 120T do not match well the reference profile of intensities 110R and the reference profile of first derivatives 120R, respectively. Consequently, the boundary contour node 131T is unlikely to be detected using the reference profile of intensities 110R and/or the reference profile of first derivatives 120R.

The failure to detect the boundary 141T in the second image 150T using the method of Ref. 1 results from using an unsuitable reference profile of intensities 110R and/or an unsuitable reference profile of first derivatives 120R to search for a matching target profile of intensities 110T and/or for a matching target profile of first derivatives 120T, respectively. These reference profiles are generated arbitrarily without taking the contents of the fist image 150R into account. In the detection method of the current invention the reference profile is generated on the basis of a qualifying characteristic. In the example illustrated in FIG. 2, the qualifying characteristic is based on the location of the reference profile relative to the reference contour in the first image, namely on the distance from the reference profile node to the right end of the reference profile.

FIG. 2 schematically illustrates a detection method according to the current invention. In the left column, there are two reference profiles: a reference profile of intensities 210R and a related reference profile of first derivatives 220R, which are generated using data from a schematic first image 250R. The first image comprises same structures as shown in image 150R in FIG. 1. The three areas of different intensities are separated by reference boundaries 241R and 242R. The first reference boundary 241R is delineated by a reference contour 240R represented by a plurality of reference contour nodes. The reference profile base 230R of the reference profile of intensities 210R and of the reference profile of first derivatives 220R and the reference contour 240R intersect each other defining the reference profile node 231R. The reference profile node 231R coincides with a reference contour node. However, unlike the reference profile base 130R in FIG. 1, the reference profile base 230R does not intersect the second reference contour 242R. Such choice of the reference profile base requires that the reference profile node 231R be substantially off the center of the reference profile base 230R. As a result, the reference profile of intensities 210R comprises fewer features, namely one reference vertical edge 211T at the location of the reference profile node 231R. Similarly, the reference profile of first derivatives 220R comprises fewer features, namely one reference peak 221R at the location of the reference profile node 231R.

In the right column of FIG. 2, there are two target profiles: a target profile of intensities 210T and a related target profile of first derivatives 220T, which are generated using data from a schematic second image 250T. The second image 250T comprises same structures as shown in image 150T in FIG. 1. Also, like the first image 250R, the second image 250T comprises three areas of different intensities, separated by target boundaries 241T and 242T. The structures of the second image 250T are similar to those comprised in the first image 250R. However, the target boundaries 241T and 242T in the second image 250T are displaced relative to the reference boundaries 241R and 242R in the first image 250R, respectively. A contour 240T represented by a plurality of reference contour nodes, mapped from the first image 250R into the second image 250T, shows the original location of the first reference boundary 241R. The target base 230T of the target profile of intensities 210T and of the target profile of first derivatives 220T and the first target boundary 241T intersect each other at the boundary contour node 231T, which has to be detected. The location of the boundary contour node 231T relative to the target base 230T is the same as the location of the reference contour node 231R relative to the reference profile base 230R. Thus, the target profile of intensities 210T and the target profile of first derivatives 220T match the reference profile of intensities 210R and the reference profile of first derivatives 220R, respectively. Indeed, like the reference profile of intensities 210R, the target profile of intensities 210T comprises one vertical edge—the target vertical edge 211T—at the location of the boundary node 231T. Similarly, like the reference profile of first derivatives 220R, the target profile of first derivatives 220T comprises one peak—the target peak 221R—at the location of the boundary node 231T. Consequently, the reference profile node 231R is mapped onto the boundary profile node 231T and the boundary profile node 231T is successfully detected using the reference profile of intensities 210R and/or the reference profile of first derivatives 220R.

The skilled person will understand that the profiles of intensities and the profiles of first derivatives are just examples that may be employed in an implementation of the present invention and that their use in the description of the embodiments does not limit the scope of the claims. Similarly, the vertical edges and peaks are just an example of profile features used to illustrate the invention. Other features may also be useful.

FIG. 3A shows a flowchart of an exemplary embodiment of the detection method 300 of detecting a boundary in a second image data from an image dataset on the basis of a reference contour in a first image data from the image dataset, the detection method 300 comprising:

a generating step 320 for generating a reference profile using the first image data on the basis of a qualifying characteristic, the reference profile comprising a reference profile node defined on the basis of the reference contour;

a selecting step 330 for selecting a target profile using the second image data on the basis of the reference profile; and

a mapping step 335 for mapping the reference profile node into the second image data on the basis of the target profile, thereby detecting the second boundary.

With further reference to FIG. 3A an initializing step 301 labeled “START” comprises initialization tasks. In a first data step 305 labeled “Get first image data” the first image data is selected from the image dataset. In a reference contour step 310 labeled “Determine reference contour” a reference contour in the first image dataset is determined. The reference contour can be obtained, for example, from manual segmentation. Alternatively, the reference contour can be obtained using an automated or a semi-automated contour detection method 300, for example, a method based on feature detection. The second image data is selected from the image dataset in a second data step 315 labeled “Get second image data”. The reference profile comprising a reference profile node is generated using the first image data in a generating step 320 labeled “Generate reference profile”. The reference profile can be adjusted in an adjusting step 325 labeled “Adjust reference profile”. In a selecting step 330 labeled “Select target profile”, a target profile matching the reference profile is selected using the second image data. In a mapping step 335 labeled “Map reference profile node” the reference profile comprising the reference profile node is mapped into the second image data on the basis of the target profile matching the reference profile. An inner loop step 340 labeled “Next reference profile node?” is the last step of the inner loop. In this step a condition, whether there is another reference profile node that has to be mapped into the second image data, is checked. If there is another reference profile node that has to be mapped into the second image data, the arrow labeled “i-YES” is followed. Another reference profile comprising another reference profile node is generated in generating step 320 “Generate reference profile” and the next inner loop cycle continues. If all reference profile nodes of the reference contour are mapped into the second image dataset, the path labeled “i-NO” is followed and an optimizing step 345 labeled “Optimize boundary nodes” is next. At the optimizing step 345 the locations of the detected boundary nodes delineating a boundary contour are optimized. The outer loop condition is checked in an outer loop step 350 labeled “Next boundary?”. This step is the last step of the outer iteration loop. In this step a condition, whether there is another image data in the image dataset where a boundary has to be detected, is checked. If there is another image data in the image dataset where the boundary has to be detected, the arrow labeled “o-YES” is followed. The first image data is replaced with the second image data and the reference contour is replaced with the boundary contour in an update step 355 labeled “Update first image and reference contour”. The next outer loop cycle is entered at the second data step 315, at which a new second image data is selected from the image dataset. If there is no image data in the image dataset where a boundary has to be detected, the arrow labeled “o-NO” is followed, a terminating step 399 labeled “END” comprising termination tasks is carried out, and the method terminates.

The reference profile generated in the generating step 320 using the first image data and comprising a reference profile node defined on the basis of the reference contour determines the target profile selected using the second image data on the basis of the reference profile. The reference profile and the target profile determine the mapping of the reference profile node into the second image data. The mapping of the reference profile node into the second image data determines the boundary node. The set of boundary nodes defines the boundary contour delineating the boundary in the second image data. Hence, the success of the detection method of detecting a boundary in the second image data relies on the reference profile. Therefore the reference profile must be generated with great care to enable finding the best possible target profile. To improve the generation of the reference profile, the reference profile of the current invention is generated on the basis of a qualifying characteristic. Certain qualifying characteristics such as an angle between the reference contour and the base of the reference profile and/or a distance from the reference profile node comprised in the base of the reference profile to a predefined end of the base of the reference profile can be imposed on the reference profile by using a proper generation method. Other qualifying characteristics such as the type and/or the number of features comprised in the reference profile must be computed for a candidate reference profile from the first image data. After evaluating the qualifying characteristic of the candidate reference profile, the candidate reference profile is accepted or rejected as the reference profile. A reference profile generated on the basis of a qualifying characteristic is more accurate in detecting the boundary in the second image than an arbitrarily generated reference profile. Hence, the detection method 300 of the current invention is more accurate in detecting a boundary in a second image data from an image dataset on the basis of a reference contour in a first image data from the image dataset.

In an embodiment of the detection method 300 according to the invention, the qualifying characteristic is based on a location of the reference profile relative to the reference contour. Examples of qualifying characteristics of this type comprise the length of the base of the reference profile, the distribution of sampling points in the reference profile, the angle between the reference contour and the base of the reference profile, and the distance from the reference profile node to an end of the base of the reference profile. The length of the reference profile and the distance from the reference profile node comprised in the reference profile to an end of the base of the reference profile are selected on the basis of the image data and/or of the structure of interest comprised in the image dataset. For example, two different profiles may be used for extracting myocardium boundaries: one reference profile comprising an epicardial reference profile node for detecting the epicardial boundary and another reference profile comprising an endocardial reference profile node for detecting the endocardial boundary. The user of the method is able to choose an advantageous length of the reference profile and an advantageous location of the reference profile node. A reference profile with a base substantially perpendicular to the reference contour tends to be more accurate than a reference profile with a base intersecting the reference contour at an angle substantially different from the right angle, when used for detecting a boundary node in the second image data. The definition of a radial direction, i. e. of a direction, which is perpendicular to the reference contour at a reference profile node, is given in Section II A of an article “Discrete Dynamic Contour Model” by Steven Lobregt and Max. A. Viergever published in IEEE Transactions on Medical Imaging, Vol. 14, No. 1, March 1995, pp. 12-24, hereinafter referred to as Ref. 2. Other directions may also be defined on the basis of the radial direction. Optionally, the reference profile, and hence the qualifying characteristics, may be optimized as described in the description of further embodiments of the detection method 300 according to the current invention.

In an embodiment of the detection method 300 according to the invention, the reference profile node is located in a substantially off-center position of the reference profile, possibly near an end of the base. In case of detecting a boundary in a second image data comprising multiple boundaries this method allows generating a reference profile, which may cross fewer boundaries and thus may comprise fewer features than a reference profile comprising the reference profile node near the center of the base. Thus a reference profile with a reference profile node in a substantially off-center position is more likely to be matched by a correct target profile selected from the second image data in the selecting step 330. For example, in case of an exterior boundary and an interior boundary of a wall structure, such as epi- and endocardial boundaries of myocardium, the reference profile generated according to the current invention intersects with only the boundary delineated by the reference contour. This is illustrated in FIG. 2. Thus the reference profile is independent of the distance between the external and internal boundaries in the first image data. The correct matching target profile can be found even if the distance between the external and internal boundaries in the second image data is quite different from the distance between the external and internal boundaries in the first image data.

In an embodiment of the detection method 300 according to the invention, the qualifying characteristic is based on a feature of the reference profile. Examples of features of the reference profile comprise, but are not limited to, a vertical edge of a reference profile of intensities and the number thereof. An example of a complex feature of a reference profile is a sequence of two vertical edges: one rising edge followed by a falling edge. The heights of vertical edges, the slopes of vertical edge, and/or the distance between the raising edge and the falling edge may also be specified in the definition of a feature. The present embodiment allows generating multiple candidate reference profiles and evaluating the generated candidate reference profiles on the basis of the qualifying characteristic. A candidate reference profile comprising the predefined features may be accepted as the reference profile. An embodiment of a generating step 320 for generating the reference profile on the basis of multiple candidate reference profiles is schematically shown in FIG. 3B.

FIG. 3B shows a flowchart of an exemplary embodiment of the generating step 320 for generating the reference profile comprising:

an extracting step 321 for extracting a candidate reference profile from the first image data;

a computing step 322 for computing a qualifying characteristic of the candidate reference profile; and

an accepting step 323 for accepting the candidate reference profile as the reference profile on the basis of the qualifying characteristic.

Multiple candidate reference profiles are evaluated on the basis of the qualifying characteristic. A candidate reference profile comprising a predefined qualifying characteristic is accepted as the reference profile. The choice of a useful qualifying characteristic of the reference profile may be very helpful in selecting the target profile in the selecting step 330.

In an embodiment of the detection method 300 according to the invention, the qualifying characteristic is based on a measure of similarity of the reference profile to the target profile. In this embodiment the generating step 320 for generating a reference profile and the selecting step 330 for selecting a target profile are merged together. A candidate reference profile is extracted and used for selecting a candidate target profile. A measure of similarity of the candidate reference profile to the candidate target profile is computed. The measure of similarity is the normalized root mean square error (NRMSE) defined in Ref. 1, Section IV B, p. 332. Alternatively, other measures of similarity such as the maximum absolute difference between the candidate reference profile and the candidate target profile can also be used. If NRMSE is less than a predefined threshold, the candidate reference profile is accepted as the reference profile and the matching candidate target profile is accepted as the target profile. Alternatively, another condition such as the condition that the measure of similarity attains an optimum, for example a maximum, may also be used. Known optimization methods such as the steepest ascend and the steepest descend methods or the conjugate gradient method may be employed to search for the candidate reference profile and for the candidate target profile optimizing the measure of similarity. These standard optimization methods are described, for example, in W. H. Press, S. A. Teukolsky, W. T. Vetterling and B. P. Flannery, Numerical Recipes in C: The Art of Scientific Computing, 2nd Ed., Cambridge University Press, 1992, Chap. 10.

In an embodiment of the detection method 300 according to the invention, the detection method 300 comprises an adjusting step 325 for adjusting the reference profile. Optionally, the adjusting step 325 may be comprised within the generating step 320 and may be applied to every candidate reference profile. The reference profile may be smoothed to reduce the influence of artifacts present in the first image data on the reference profile. Various filtering methods may be used to smooth the reference profile. The tangential filtering of a reference profile proves particularly useful. Optionally, the reference profile may be clipped to decrement the number of features comprised in the reference profile.

FIG. 4 explains the tangential filtering method applied to an image data 400. A reference contour 411 delineates a boundary in the image data 400. A plurality of reference profiles 412 of identical length is generated in the generating step 320. These reference profiles are arranged next to each other in a so-called profile image 410, where each horizontal line represents one reference profile. The arrow 413 shown in the image data 400 and in the profile image 410 indicates the ordering of the reference profiles 412. Low-pass filter using a Gaussian filter kernel may be applied to the profile image in the vertical direction coinciding with the direction tangential to the reference contour 411. A filtered profile image 420 is also shown in FIG. 4.

The skilled person will understand that there are other ways of adjusting the reference profile and that the way employed in this embodiment illustrates the invention and does not limit the scope of the claims.

In an embodiment of the detection method 300 according to the invention, the candidate target profiles are adjusted in the selecting step 335. The detection method 300 is arranged to scale the values of the candidate target profile to improve the match between the reference profile and the adjusted target profile. Optionally, the candidate target profiles may be smoothed to reduce the influence of artifacts present in the second image data on the similarity measure. The skilled person will understand that there are many other methods of adjusting candidate target profiles and that the methods described in this application are for illustration purpose only and do not limit the scope of the claims.

In an embodiment of the detection method 300 according to the invention, the locations of the detected boundary nodes are optimized in the optimizing step 345. To this end a boundary contour energy is defined. For example, in Section II of Ref. 1 the boundary contour energy comprises a bending energy term and a stretching energy term. The boundary contour energy is minimized. The bending energy is minimal when the boundary contour local curvature is constant. The stretching energy is minimal when the displacements of the boundary contour nodes from their detected locations are zero. The locations of the boundary contour nodes at a minimum of the boundary contour energy yield the optimized locations of the optimized boundary contour nodes.

Alternatively, the detected locations of the boundary nodes are used to define centers of external forces attracting and/or repulsing the boundary nodes. The boundary nodes are also arranged to interact with each other via internal forces. Various force fields are described in the literature. For example, in Section II A of Ref. 2 the internal forces are constructed in such a way that local curvature of the boundary contour is reduced without affecting parts of the contour with constant curvature. In Section II B of Ref. 2 the external force acting on a boundary node is defined on the basis of the radial component of the gradient vector of intensities of the second image data at the location of the boundary node. Alternatively, the external force may be defined on the basis of the integral of the absolute value of the difference between the reference profile and the target profile. The optimized locations of the boundary nodes are defined by equilibrium of the external and internal forces. The optimized locations of the boundary nodes can be computed by solving an equation of motion of the boundary nodes in the defined force field. The initial locations of the boundary nodes are the centers of the external forces. Alternatively, the initial location of a boundary node may be defined by a projection of the respective reference profile node into the second image data. The optimization can be carried out using simulation. In order to improve convergence of the simulation, friction forces may be also added to the force field. Furthermore, a method of optimizing the locations of the boundary nodes is based on optimizing the total energy of the boundary contour comprising an external energy term and an internal energy term. The optimal locations of the boundary nodes are defined by an optimum such as a minimum of the total energy.

The optimization of the boundary contour nodes is used to smooth the boundary contour. The skilled person will understand that the optimizing step 345 is optional and that there are various ways to optimize the boundary contour. Thus the scope of the claims is not limited by any particular optimization or by the lack thereof.

In an embodiment of the detection method 300 according to the invention, the optimizing step 345 for optimizing the boundary contour comprises resampling. If the number of nodes comprised in the boundary contour is inadequate, the boundary contour is resampled and new boundary nodes defining the boundary contour are generated. A method of resampling a boundary contour is described in Section III of Ref 2. The skilled person will understand that there are several ways to resample the boundary contour and that the scope of the claims does not relay on any particular resampling method.

In a preferred embodiment of the detection method 300 according to the invention, the intersection of the base of the generated reference profile and of the reference contour coincides with a reference contour node. Thus the reference profile node coincides with a reference contour node. The number of boundary contour nodes is the same as the number of reference contour nodes. However, this is not a necessary requirement. The skilled person will appreciate that the intersection of the base of the generated reference profile and of the reference contour does nod need to coincide with a reference contour node. Thus the reference profile node can be at an arbitrary location on the reference contour.

In an embodiment of the detection method 300 according to the invention, the first image data corresponds to a first cross-section of the image dataset by a first plane and the second image data corresponds to a second cross-section of the image dataset by a second plane wherein the first plane and the second plane are substantially mutually parallel. Thus the method is useful for detecting boundaries in the image dataset arranged as a sequence of cross sections by substantially mutually parallel planes, for example, for detecting boundaries in a stack of MR slices. Such arrangement is particularly advantageous for segmenting an object comprised in the image dataset on the basis of the detected boundaries. For example, the detection method 300 is useful for detecting epi- and endocardial boundaries in a stack of MR slices corresponding to the short-axis or to the long-axis MR recordings. The epi- or endocardial reference contour defined by reference contour nodes in the first image data is mapped into the second image data for delineating the epi- or endocardial boundary, respectively, in the second image data. The boundary contour delineating the detected boundary in the second image data can be further used in the update step 355 and in the following steps of the outer loop to delineate the epi- or endocardial boundary, respectively, in a third image data. Advantageously, the method is useful for detecting boundaries of a variety of objects in medical image datasets generated by various data acquisition modalities such as MRI, CT, US, PET, and SPECT.

In an embodiment of the detection method 300 according to the invention, the first image data corresponds to a first data acquisition time and the second image data corresponds to a second data acquisition time. Thus the detection method 300 is useful for detecting a moving boundary depicted in a time-series of image data comprised in the image dataset. For example, the detection method 300 is useful for detecting epi- and endocardial boundaries in a sequence of frames, each frame depicting same MR slice acquired at a different phase of the cardiac cycle

In a preferred embodiment of the detection method 300 according to the invention, the detection method 300 is used for detecting open and/or closed 1D boundaries delineated by contours in a 2D image data from a 3D image dataset. The skilled person will appreciate the fact that the method can be used to detect open and/or closed 2D boundaries delineated by surface models such as triangular meshes in a 3D image data from a 4D image dataset. Preferably, a reference profile is assigned to every face of the mesh. The base of the reference profile is perpendicular to this face and intersects the face at the center. Alternatively, a reference profile may be assigned to each node of the mesh. Other arrangements are also possible.

The order in the described embodiments of the method of the current invention is not mandatory, the skilled person may change the order of some steps or perform some steps concurrently using threading models, multi-processor systems or multiple processes without departing from the concept as intended by the present invention. Optionally, two steps of the method of the current invention can be combined into one step. Optionally, a step of the detection method 300 of the current invention can be split into a plurality of steps.

FIG. 5 schematically shows an embodiment of the detection system 500 for detecting a boundary in a second image data from an image dataset on the basis of a reference contour in a first image data from the image dataset, the detection system 500 comprising:

a first data unit 505 for selecting the first image data from the image dataset;

a contour unit 510 for determining a reference contour in the first image dataset;

a second data unit 515 for selecting the second image data from the image dataset;

a generating unit 520 for generating a reference profile using the first image data on the basis of a qualifying characteristic, the reference profile comprising a reference profile node;

an adjusting unit 525 for adjusting the reference profile;

a selecting unit 530 for selecting a target profile using the second image data on the basis of the reference profile;

a mapping unit 535 for mapping the reference profile node into the second image data on the basis of the target profile, thereby detecting the boundary in the second image data;

an inner loop unit 540 for checking whether there is another reference profile node that has to be mapped into the second image data;

an optimizing unit 345 for optimizing the detected boundary nodes;

an outer loop unit 550 for checking whether there is another image data in the image dataset in which a boundary has to be detected;

an update unit 555 for replacing the first image data with the second image data and for replacing the reference contour with the detected boundary;

a segmentation unit 560 for segmenting the image dataset on the basis of the detected boundary; and

a user interface 565 for communicating with the detection system 500.

In the embodiment of the detection system 500 shown in FIG. 5, there are three input connectors 581, 582 and 583 for the incoming data. The first input connector 581 is arranged to receive data coming in from data storage such as a hard disk, a magnetic tape, flash memory, or an optical disk. The second input connector 582 is arranged to receive data coming in from a user input device such as a mouse or a touch screen. The third input connector 583 is arranged to receive data coming in from a user input device such as a keyboard. The input connectors 581, 582 and 583 are connected to an input control unit 580.

In the embodiment of the detection system 500 shown in FIG. 5, there are two output connectors 591 and 592 for the outgoing data. The first output connector 591 is arranged to output the data to data storage such as a hard disk, a magnetic tape, flash memory, or an optical disk. The second output connector 592 is arranged to output the data to a display device. The output connectors 591 and 592 receive the respective data via an output control unit 590.

The skilled person will understand that there are many ways to connect input devices to the input connectors 581, 582 and 583 and the output devices to the output connectors 591 and 592 of the detection system 500. These ways comprise, but are not limited to, a wired and a wireless connection, a digital network such as a Local Area Network (LAN) and a Wide Area Network (WAN), the Internet, a digital telephone network, and an analogue telephone network.

In an embodiment of the detection system 500 according to the invention, the detection system 500 comprises a memory unit 570. The memory unit 570 is arranged to receive an input data from external devices via any of the input connectors 581, 582, and 583 and to store the received input data in the memory unit 570. Loading the data into the memory unit 570 allows a quick access to relevant data portions by the units of the detection system 500. The input data comprises the image dataset. The memory unit 570 can be implemented by devices such as a Random Access Memory (RAM) chip, a Read Only Memory (ROM) chip, and/or a hard disk. Preferably, the memory unit 570 comprises a RAM for storing the image dataset. The memory unit 570 is also arranged to receive data from and to deliver data to the units of the detection system 500 comprising the first data unit 505, the contour unit 510, the second data unit 515, the generating unit 520, the adjusting unit 525, the selecting unit 530, the mapping unit 535, the inner loop unit 540, the optimizing unit 545, the outer loop unit 550, the update unit 555, the segmentation unit 560, and the user interface 565 via the memory bus 575. The memory unit 570 is further arranged to make the data available to external devices via any of the output connectors 591 and 592. Storing the data from the units of the detection system 500 in the memory unit 570 advantageously improves the performance of the units of the detection system 500 as well as the rate of transfer of data from the units of the detection system 500 to external devices.

Alternatively, the detection system 500 does not comprise the memory unit 570 and the memory bus 575. The input data used by the detection system 500 is supplied by at least one external device, such as external memory or a processor, connected to the units of the detection system 500. Similarly, the output data produced by the detection system 500 is supplied to at least one external device, such as external memory or a processor, connected to the units of the detection system 500. The units of the detection system 500 are arranged to receive the data from each other via internal connections or via a data bus.

In a further embodiment of the detection system 500 according to the invention, the detection system 500 comprises a user interface 565 for communicating with the detection system 500. The user interface 565 comprises a display unit for displaying data to the user and a selection unit for making selections. Combining the detection system 500 with a user interface 565 allows the user to communicate with the detection system 500. The user interface 565 is arranged to display views rendered from the first and/or from the second image data to the user. The user interface 565 may be further arranged to display the reference contour and/or the boundary contour. Optionally, the user interface may comprise a plurality of modes of operation of the detection system 500 such as a mode using a particular optimizing method. The skilled person will understand that more functions can be advantageously implemented in the user interface 565 of the detection system 500.

Alternatively, the detection system can employ an external input device and/or an external display connected to the detection system 500 via the input connectors 582 and/or 583 and the output connector 592. The skilled person will also understand that there exist many user interfaces that can be advantageously comprised in the detection system 500 of the current invention.

In a further embodiment of the detection system 500 according to the invention, the detection system further comprises a segmentation unit 560 for segmenting the image dataset on the basis of the detected boundary. By combining the detected boundaries from multiple 2D image data such as MR slices, the segmentation unit 560 can assemble an object comprised in the 3D image dataset such as a heart. The user interface 565 can be further arranged to render and display projections, such as the iso-Surface Projection or the Maximum Intensity Projection.

The detection system 500, such as the one shown in FIG. 5, of the invention may be implemented as a computer program product and can be stored on any suitable medium such as, for example, magnetic tape, magnetic disk, or optical disk. This computer program can be loaded into a computer arrangement comprising a processing unit and a memory. The computer program product, after being loaded, provides the processing unit with the capability to carry out the rendering, tasks.

FIG. 6 schematically shows an embodiment of the image acquisition system 600 employing the detection system 500 of the invention, said image acquisition system 600 comprising an image acquisition system unit 610 connected via an internal connection with the detection system 500, an input connector 601, and an output connector 602. This arrangement advantageously increases the capabilities of the image acquisition system 600 providing said image acquisition system 600 with advantageous boundary detection and/or segmentation capabilities of the detection system 500. Examples of image acquisition systems are, but not limited to, a CT system, an X-ray system, an MRI system, an Ultrasound system, a Positron Emission Tomography (PET) system, and a Single Photon Emission Computed Tomography (SPECT) system.

FIG. 7 schematically shows an embodiment of the workstation 700. The system comprises a system bus 701. A processor 710, a memory 720, a disk input/output (I/O) adapter 730, and a user interface (UI) 740 are operatively connected to the system bus 701. A disk storage device 731 is operatively coupled to the disk I/O adapter 730. A keyboard 741, a mouse 742, and a display 743 are operatively coupled to the UI 740. The detection system 500 of the invention, implemented as a computer program, is stored in the disk storage device 731. The workstation 700 is arranged to load the program and input data into memory 720 and execute the program on the processor 710. The user can input information to the workstation 700 using the keyboard 741 and/or the mouse 742. The workstation is arranged to output information to the display device 743 and/or to the disk 731. The skilled person will understand that there are numerous other embodiments of the workstation known in the art and that the present embodiment serves the purpose of illustrating the invention and must not be interpreted as limiting the invention to this particular embodiment.

It should be noted that the above-mentioned embodiments illustrate rather than limit the invention and that those skilled in the art will be able to design alternative embodiments without departing from the scope of the appended claims. In the claims, any reference signs placed between parentheses shall not be constructed as limiting the claim. The word “comprising” does not exclude the presence of elements or steps not listed in a claim. The word “a” or “an” preceding an element does not exclude the presence of a plurality of such elements. The invention can be implemented by means of hardware comprising several distinct elements and by means of a suitable programmed computer. In the system claims enumerating several units, several of these units can be embodied by one and the same item of hardware or software. The usage of the words first, second and third, etcetera does not indicate any ordering. These words are to be interpreted as names.

1. A detection method (300) of detecting a boundary in a second image data from an image dataset on the basis of a reference contour in a first image data from the image dataset, the detection method (300) comprising:
a generating step (320) for generating a reference profile using the first image data on the basis of a qualifying characteristic, the reference profile comprising a reference profile node defined on the basis of the reference contour;
a selecting step (330) for selecting a target profile using the second image data on the basis of the reference profile; and
a mapping step (335) for mapping the reference profile node into the second image data on the basis of the target profile, thereby detecting the second boundary.

2. A detection method (300) as claimed in claim 1 wherein the qualifying characteristic is based on a location of the reference profile relative to the reference contour.

3. A detection method (300) as claimed in claim 2 wherein the reference profile node is located in a substantially off-center position of the reference profile.

4. A detection method (300) as claimed in claim 1 wherein the qualifying characteristic is based on a feature of the reference profile.

5. A detection method (300) as claimed in claim 1 wherein the qualifying characteristic is based on a measure of similarity of the reference profile to the target profile.

6. A detection method (300) as claimed in claim 1 further comprising an adjusting step (325) for adjusting the reference profile.

7. A detection method (300) as claimed in claim 1 wherein the first image data corresponds to a first cross-section of the image dataset by a first plane and the second image data corresponds to a second cross-section of the image dataset by a second plane wherein the first plane and the second plane are substantially mutually parallel.

8. A detection method (300) as claimed in claim 1 wherein the first image data corresponds to a first data acquisition time and the second image data corresponds to a second data acquisition time.

9. A detection system (500) for detecting a boundary in a second image data from an image dataset on the basis of a reference contour in a first image data from the image dataset, the detection system (500) comprising:
a generating unit (520) for generating a reference profile using the first image data on the basis of a qualifying characteristic, the reference profile comprising a reference profile node defined on the basis of the reference contour;
a selecting unit (530) for selecting a target profile using the second image data on the basis of the reference profile; and
a mapping unit (535) for mapping the reference profile node into the second image data on the basis of the target profile, thereby detecting the second boundary.

10. A detection system as claimed in claim 9 further comprising a segmentation unit (560) for segmenting the image dataset on the basis of the detected boundary.

11. An image acquisition system (600) for acquiring an image dataset comprising a detection system (500) as claimed in claim 9.

12. A workstation (700) comprising a detection system (500) as claimed in claim 9.

13. A computer program product to be loaded by a computer arrangement, comprising instructions for detecting a boundary in a second image data from an image dataset on the basis of a reference contour in a first image data from the image dataset, the computer arrangement comprising a processing unit and memory, the computer program product, after being loaded, providing said processing unit with the capability to carry out the following tasks:
generating a reference profile using the first image data on the basis of a qualifying characteristic, the reference profile comprising a reference profile node defined on the basis of the reference contour;
selecting a target profile using the second image data on the basis of the reference profile; and
mapping the reference profile node into the second image data on the basis of the target profile, thereby detecting the second boundary.
